(19) United States
(12) Patent Application Publication
(10) Pub. No.: US 2002/0111931 A1
(43) Pub. Date: Aug. 15, 2002

(54) Databases

(76) Inventor: Jeffrey John Richards, Staffordshire (GB)

Correspondence Address: Jeffrey J. Schwartz, Adams, Schwartz & Evans, P.A., 2180 Two First Union Center, Charlotte, NC, 28282, US

(21) Appl. No.: 09/898,995

(22) Filed: Jul. 3, 2001

(30) Foreign Application Priority Data
Jan. 27, 2001 (GB) 0102220.1

(51) Int. Cl. G06F 7/00

(52) U.S. Cl. 707/1

(57) ABSTRACT

Apparatus 10 includes a database stored at 16. Requests from users are received over a connection 14. Sub-sets of data from the database 16 are sent to storage at 18 and retrieved by one of a bank of processors 20 to be processed to create the requested result set, which is returned to the storage 18. Data extraction to the storage 18, and data processing by the processors 20 can each be effected in parallel, increasing the overall speed of response to requests.

The present invention relates to databases and in particular, to methods and apparatus for operating on the contents of the database to produce a result set from those contents.

During recent years, computer databases have increased in size, complexity and importance. Many organisations, particularly large commercial organisations, seek to maintain central computer databases accessible throughout the organisation to ensure that information is efficiently and consistently used throughout the organisation. For instance, a chain of retail stores may maintain a central database of prices, stock, sales figures etc., to which each store in the chain will refer as required. This allows the same information to be available to all of the stores and also to assist management functions.

The contents of the database are used by a user who makes a request to produce a result set based on those contents, such as sales figures for a particular store, stock levels for a specified range of products, or the like. As the range of result sets required, and the potential number of users, both increase, the demands on the system which produces result sets from the database contents will also increase.

In a conventional arrangement, a computer will have access to the database contents stored in memory, and processing capability able to act on those contents in order to produce a result set in response to a request. The capacity of the memory will need to be increased as the size of the database increases. The processing power of the computer will need to increase as the number of users and requests increases, and also as the complexity of the result sets increases. In a growing organisation, such as a retail chain opening additional outlets, the demands on the database computer may increase quickly, sometimes in step-wise fashion. This may adversely affect the performance of the computer, particularly by slowing response times. In practice, it may be difficult to upgrade the database computer as quickly as is required to deal with the increasing demands. The result may be steadily deteriorating performance causing frustration among users and removing some of the efficiencies to be gained from the provision of a central database.

The present invention provides apparatus for operating on the contents of a database to produce a result set relating to those contents, the apparatus comprising:

(a) first data storage means which stores the database contents;

(b) first control means operable to receive requests to produce a result set, and comprising first processor means operable (i) to identify one or more sub-sets of the database contents required to satisfy a request and (ii) to interrogate the first data storage means to extract the or each identified sub-set for further processing;

(c) second data storage means operable to receive and store sub-sets of data extracted by the first processor means in response to corresponding requests; and

(d) at least two second processor means operable simultaneously (i) to act upon respective sub-sets of data stored in the second data storage means to create the corresponding requested result sets and (ii) to provide the result sets for delivery to satisfy the requests.

The apparatus preferably comprises a plurality of processor means each operable selectably as first processor means and as second processor means, the apparatus further comprising second control means operable to select the manner of operation of each processor means.

The second control means preferably selects the number of the processor means to be operable as first processor means and as second processor means by reference to at least one of the following factors:

(i) the number of requests which have been received but not satisfied;

(ii) the processing resources and time required to satisfy any outstanding or expected requests;

(iii) the number of requests expected to be received by reference to the current time and to patterns of demand recorded by the second control means, and to any requests stored for execution at a specified future time or times; and

(iv) the number of processor means available for use as first or second processor means.

Preferably the first control means are operable to create a register of requests received. The register may include data representing the status of the process required to produce the corresponding result set. The register may include data representing the location of the sub-set required for producing the corresponding result set, and the location of the processed data forming the requested result set. The register may identify the first processor means allocated to each request. The register may identify the second processor means allocated to create the corresponding result set. Each first and second processor means will preferably interrogate the register after completing a task, therebeing means operable to identify tasks which have not been allocated, and to allocate an appropriate task to the interrogating processor means. The interrogating processor means is preferably operable to update the register when a task has been allocated to it.

Preferably the second control means are operable to interrogate the register to identify the tasks being undertaken by the processor means, and the identity of the processor means undertaking each of them, and are further operable to determine the time expected for completing each task and to identify any tasks which are overdue for completion. The second control means is preferably operable to reallocate an overdue task to a different processing means. The second control means is further preferably operable to disable a processor means upon that processor means becoming overdue in completing a task.

Preferably the second processor means are operable to store created result sets in the second data storage means. The first control means is preferably operable to retrieve stored created result sets for delivery.

The apparatus may comprise a plurality of first control means as aforesaid, each having associated therewith first processor means as aforesaid, second storage data storage means as aforesaid, and at least two second processor means as aforesaid, the plurality of first control means being cooperable to allocate requests between them for production of a result set as aforesaid.

In another aspect of the invention, there is provided a group of computer programs comprising:

(i) a first computer program for causing a first computer to perform as a first control means as aforesaid;

(ii) a second computer program for causing a second computer to perform as a first processor means as aforesaid; and

(iii) a third computer program for causing a third computer to perform as a second processor means as aforesaid.

The group of computer programs may further comprise a fourth computer program for causing a further computer to perform as a second control means as aforesaid.

In another aspect, the present invention provides a method of operating on the contents of a database to produce a result set relating to those contents, in which:

(a) the database contents are stored in first data storage means;

(b) first control means receives requests to produce a result set, and comprises first processor means used (i) to identify the sub-sets of the database contents required to satisfy a request and (ii) to interrogate the first data storage means to extract the identified sub-sets for further processing;

(c) second data storage means are used to receive and store sub-sets of data extracted by the first processor means in response to corresponding requests; and

(d) at least two second processor means are used simultaneously (i) to act upon respective sub-sets of data stored in the second data storage means to create the corresponding requested result sets and (ii) to provide the result sets for delivery to satisfy the requests.

Preferably comprises a plurality of processor means are selectably used either as first processor means or as second processor means.

Preferably the number of the processor means to be used as first processor means and as second processor means are selected by reference to at least one of the following factors:

(i) the number of requests which have been received but not satisfied;

(ii) the processing resources and time required to satisfy any outstanding or expected requests;

(iii) the number of requests expected to be received by reference to the current time and two patterns of demand recorded by the second control means, and to any requests stored for execution at a specified future time or times; and

(iv) the number of processor means available for use as first or second processor means.

Preferably a register of requests received is created. The register may include data representing the stage reached in the process required to produce the corresponding report. The register may include data representing the location of the sub-set required for producing the corresponding result set, and the location of the processed data forming the requested result set. The register may identify the first processor means allocated to each request. The register may identify the second processor means allocated to create the corresponding result set. Each first and second processor means will preferably interrogate the register after completing a task, there being means operable to identify tasks which are not being processed, and to allocate an appropriate task to the interrogating processor means. The interrogating processor means is preferably used to update the register when a task has been allocated to it.

Preferably the register is interrogated to identify the tasks being undertaken by the processor means, and the identity of the processor means undertaking each of them, and the time expected for completing each task is determined to identify any tasks which are overdue for completion. Preferably an overdue task is reallocated to a different processing means. Preferably a processor means is disabled upon that processor means becoming overdue in completing a processing task.

Preferably created result sets are stored in the second data storage means for retrieval and delivery.

Embodiments of the present invention will now be described in more detail, by way of example only, and with reference to the accompanying drawings, in which:

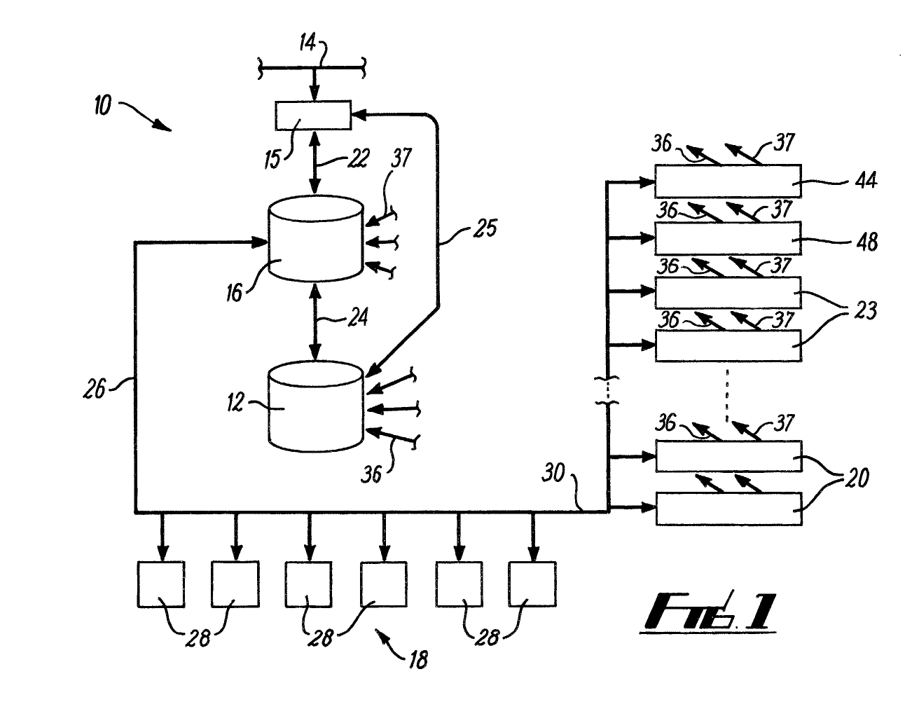

FIG. 1 is a schematic diagram of a system according to the present invention;

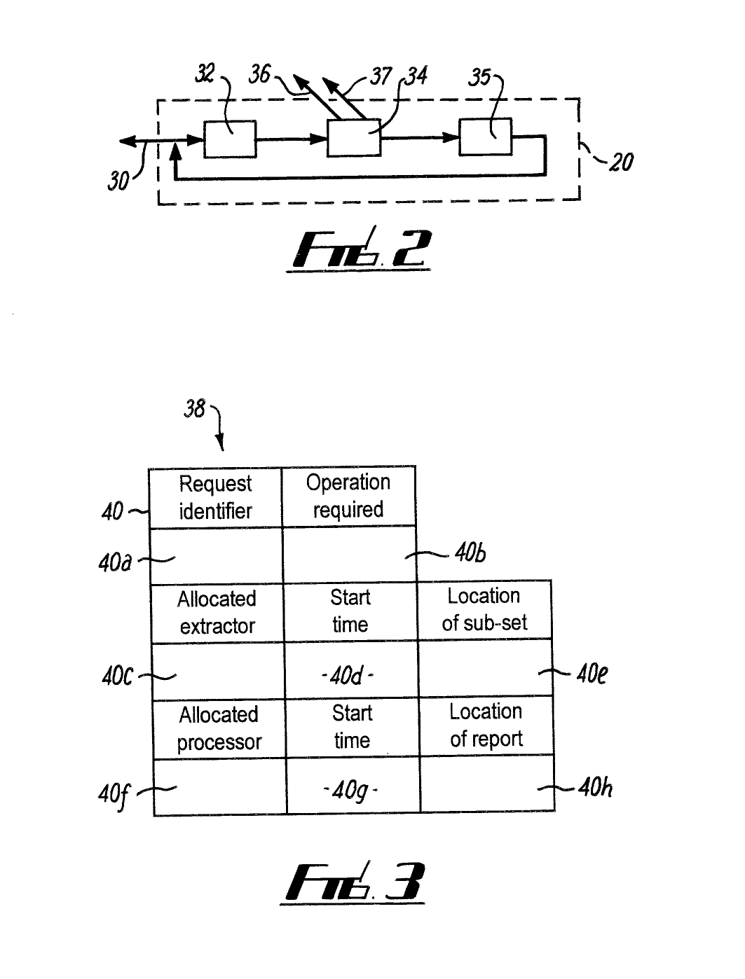

FIG. 2 is a schematic diagram of a precursor for use in the system of FIG. 1;

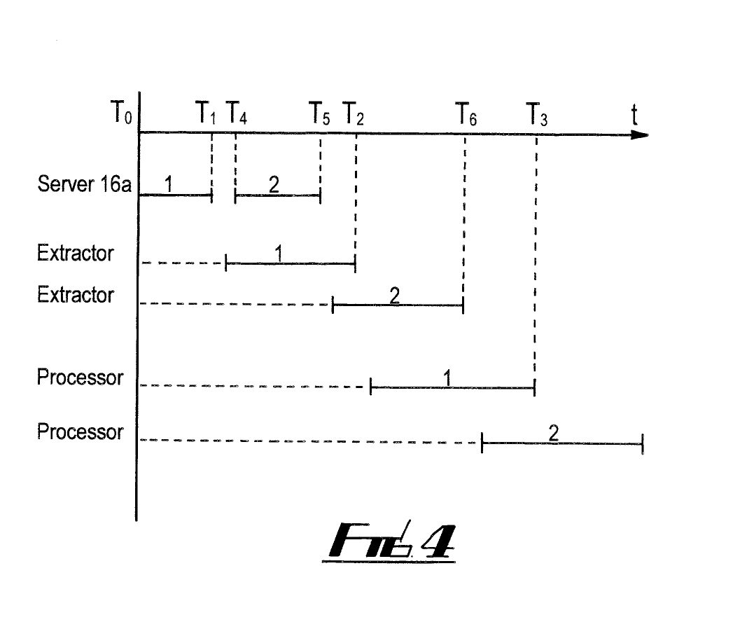

FIG. 3 illustrates a data structure for a register used within the system of FIG. 1; and

FIG. 4 is a simplified timing diagram illustrating the operation of the system of FIG. 1.

Overview

By way of introduction, an initial overview of the apparatus to be described may first be given by reference to FIG. 1. FIG. 1 illustrates apparatus 10 for operating on the contents of a database stored at 16 to produce a result set from those contents. Requests from users are received over a connection 14 by a process 15, illustrated schematically. The process 15 may be, for instance, a software package running on a computer to provide an interface between the database 16 and the users, by means of which, users may be provided with a convenient format in which to make requests and receive results. These requests will be for the production of a result set from the database contents. In many cases, only a sub-set of the data in the database 16 will be required to satisfy the request. Thus, if a particular store is requesting an analysis of sales figures for that store, the sub-set will be the sales data relating to that store. The required sub-set of data is extracted from the database in a manner to be described, and put into second data storage at 18. A bank of processors 20 has access to data in the storage 18 in order to process that data to create the requested result set, returning the result set to the storage 18 for retrieval and despatch to the user over the connection 14.

Apparatus Components and Interconnection

In more detail, the components of the apparatus, and interconnections between them, can be described in more detail, as follows.

The process 15 is implemented as computer software running on a computer connected to the connection 14, which may be a network or other communication channel over which users are able to send requests in the form of electronic signals to the process 15. The process 15 is connected at 22 to the server 16. In this example, the server 16 includes memory containing the data of the database, and software operable to manipulate the database contents. The software is preferably written in the SQL language and the server 16 is hence called an SQL server.

The server 16 is connected by a bus 24 to a computer, here designated the co-ordinator and indicated by the numeral 12, and which includes conventional processor hardware, and computer memory containing a register of activity for co-ordination purposes, as will be described.

A further bus 25 connects the process 15 to the co-ordinator 12.

The server 16 is also connected by another bus 26 to each area 28 of the data storage 18. The areas 28 are illustrated here as discrete items and may be implemented as discrete memory devices. Alternatively, one or more memory device of adequate capacity could be configured to allocate respective parts of its capacity to form separate areas 28, which are functionally discrete, but not physically discrete.

By virtue of the bus 26, the server 16 is able to pass the appropriate subset of data across the bus 26 to an area 28 which is not currently in use, over-writing any previous contents.

At this point of the operation, the appropriate area 28 will contain the sub-set of data necessary to satisfy the request, but that data will still be raw, i.e. unprocessed. Processing of the data is executed by the processors 20. Each processor 20 has a connection 30 to the memory areas 28. The connections 30 may be in the form of a shared bus, network or other appropriate form. The connections 30 allow the processors 20 to retrieve data from any area 28. The processors 20, to be described in more detail below, are computers able to process data retrieved from the areas 28 in order to create the corresponding report requested, i.e. to process the raw data to produce analysed data which can then be returned to an area 28 to form the result set for delivery to satisfy the request. The completed result set can then be extracted from the area 28 by the server 16, and sent through the process 15 and connection 14 to the user.

FIG. 2 illustrates a processor 20 in more detail. The processor 20 is schematically shown as consisting of a first read/write memory device 32 connected to the bus 30 for receiving a sub-set of data from a data storage area 28. A computer 34 is connected to the memory 32 and, under appropriate software control, is able to process a sub-set of data in the memory 32, to produce a result set stored in a second read/write memory device 35. The memory 35 is connected to the connection 30 for sending the result set back to a data storage area 28.

The processor 20 is also connected by a bus 36 to the coordinator 12, and by a bus 37 to the server 16.

While the processor 20 has been described and illustrated as having three main components 32, 34, 35, it will be readily apparent that this division is primarily functional and that the hardware implementation of the components 32, 34, 35 could be varied considerably in accordance with the technology chosen for the implementation. In particular, the memories 32, 35 may form part of the memory of the computer 34 and need not be wholly separate. A single memory could be used for incoming data and outgoing result sets.

In addition to a bank processors 20, the apparatus 10 further comprising a bank of extractors 23, a monitor 44 and a switch circuit 48. The extractors 23, monitor 44 and switch 48 are preferably all implemented in hardware identical with the processors 20, which allows the hardware to be interchangeable in the event of failure, and for other reasons to be described. The purpose of the extractors 23 and switch 48 will be explained below.

Thus, it will be apparent from the above description that when the apparatus is in use, a request received by the process 15 is first analysed to extract the necessary sub-set of data from the server 16 to a memory area 28. A processor 20 is then used to process that data, returning the resulting result set to an area 28, from which the result set can be retrieved by the server 16 and passed to the user by the process 15.

This operation requires co-ordination. In particular, coordination is required because the apparatus 10 includes a plurality of memory areas 28, a plurality of processors 20 and a plurality of extractors 23. This duplication provides significant advantages when appropriately co-ordinated, as will now be described.

Extraction, Processing Co-ordination, Monitoring and Control

The above description has indicated that a request from a user is analysed in order to identify and extract an appropriate data sub-set from the database. In this example, analysis of a particular request is undertaken by an extractor 23 acting in conjunction with the SQL server 16. Thus, if a request was for an analysis of sales figures for a particular store in a chain of stores of a retail organisation, the relevant sub-set of data is all data relating to sales in that store, whereas sales in other stores would not be relevant and would not be included in the sub-set. Conversely, a user seeking management information might make a request for sales figures of a particular item, analysed by store, in which case the appropriate sub-set would include all data relating to sales of that item, regardless of the store, but any data relating to sales of other items would not be included in the sub-set. These two examples are extremely simple but illustrate the manner in which a request will be analysed in order to identify a sub-set required. Naturally, many commercial situations may give rise to requests of much greater complexity than this, requiring more complex analysis and resulting in a sub-set of data which is more precisely defined.

Subsequent processing to create the final result set is carried out by a processor 20. In view of the duplication of extractors and processors, it will be readily apparent that in order for the apparatus 10 to avoid duplication of operations, it will be necessary to allocate one of the extractors 23 to control the production of a data sub-set, and to allocate one of the processors 20 to provide the processing operations required to convert a particular sub-set of data into a result set to fulfil a corresponding request. This co-ordination relies on the existence of a register maintained within the co-ordinator 12 and containing data fields illustrated in FIG. 3. FIG. 3 illustrates the data fields in three rows. The upper row of fields are controlled by the process 15. When the process 15 receives a request, the process 15 will allocate an identifier (such as a sequential number) to identify the corresponding request and will record that identifier in field 40a of the register 38 by communication with the co-ordinator 12 over the bus 25. The process 15 will also record, at 40b, the operation required in order to fulfil the request identified at 40a. The contents of field 40b will include any parameters required to complete the necessary operation correctly. In many practical implementations, the contents of data field 40b may be complex, with the necessary complexity generally increasing with the range of different types of request which the apparatus 10 must cater for.

The middle row of the register entry in FIG. 3 is used by an extractor 23. In order to access the register 38, each extractor 23 has a connection 36 between its computer 34 and the co-ordinator 12 as has been described.

Any extractor 23 which is not currently occupied in extracting a data sub-set will interrogate the register 38 through the connection 36 to identify a register entry which records a request at 40a, but for which data fields 40c, 40d and 40e are blank. Data field 40c records the identity of an extractor 23 which has been allocated to extract the data sub-set required to fulfil the request identified at 40a. Upon finding such a blank entry, the computer 34 of the extractor 23 will identify itself by making an appropriate entry in data field 40c. Having done this, the corresponding request, identified at 40a, will thereafter be ignored by other extractors 23 which are looking for unallocated extraction operations.

The allocated extractor 23 will then interrogate data fields 40a, 40b and the computer 34 of the extractor 23 will then process that information in order to determine what data sub-set will be required in order to complete the operation identified at 40b, and also to identify the instructions which the SQL server 16 will require in order to extract the appropriate data sub-set to memory 18. The extractor 23 also identifies the time at which the request has been allocated to it, recording this time by making an appropriate entry at data field 40d. At this stage, data fields 40e, to 40h will still be blank.

Having identified the instructions required by the server 16, the extractor 23 creates these instructions and communicates them to the server 16 over the bus 37. These instructions will include identification of an appropriate data storage area 28 to which the sub-set of data should be sent, identified by the extractor 23 either by interrogation of the areas 28 over the bus 30, or by the provision of additional data fields in the register 38, indicating the current status of each area 28.

The extractor 23 records at 40e the area 28 identified to receive the data sub-set.

Instructions from the extractor 23 are received by the server 16, which then operates in a manner which will be well understood by the skilled reader familiar with SQL language, to extract a sub-set of data from the database and send this to the area 28 identified by the extractor 23.

The extraction process is now complete. In summary, the process 15 has initially identified the request at 40a, and the nature of the request at 40b. An extractor which was not in use has allocated to itself the task of analysing the request and instructing the server 16 to create the data sub-set and send it to a specified area 28. Data fields 40c, 40d and 40e have been updated as appropriate, to indicate the status of this activity.

Processing of the data sub-set can now begin, which is achieved by a processor 20, as will now be described.

Any processor 20 which is not currently occupied in processing a data sub-set will interrogate the register 38 through the connection 36 to identify a register entry which records a request at 40a, and the location of a sub-set at 40e, but for which data field 40f is blank. Data field 40f records the identity of the processor 20 which has been allocated to process the data sub-set identified at 40e, by the operation identified at 40b, to fulfil the request identified at 40a. Upon finding such an entry, the computer 34 will identify itself by making an appropriate entry in data field 40f and then interrogate data fields 40a, 40b, 40e. The computer 34 will then retrieve the appropriate data sub-set to memory 32 and begin processing to create the requested result set. The processor 20 also identifies the time at which this operation begins, recording this by making an appropriate entry at data field 40g. At this stage, data field 40h will be blank.

When the processor 20 completes the processing operation and has sent the result set back to a data storage area 28, the processor 20 completes the register 38 at data field 40h to identify the location of the results. Communication with the co-ordinator 12 may be necessary to identify an available area 28.

The SQL server 16 is then able to identify, from the register 38, that the result set is complete and is at the location identified at 40h. The server 16 can therefore retrieve the result set over the bus 26, and pass it to the process 15 over the bus 22, for onward transmission to the user, over the connection 14.

In the example described above, extractors and processors are used to allocate jobs to themselves. In many implementations this may be acceptable, particularly if all processors 20 are identical and therefore all capable of executing any processing request. However, in more complex systems, the power of some processors 20 may be greater than that of others, making it appropriate to allocate jobs with reference to this power or other hardware considerations. If so, processors will take these factors into account when allocating jobs for themselves, or more preferably, the co-ordinator 12 may be responsible for allocating requests in response to a processor identifying itself as idle.

In addition to the processors 20, the apparatus 10 also incorporates a monitor 44. The monitor 44 may be implemented in hardware identical with the hardware of a processor 20 and extractor 23, and to which the same connections 30, 36, 37 are provided, the monitor 44 having a computer 34 which is appropriately programmed to cause the monitor 44 to perform in the manner set out below. Alternatively, bespoke hardware may be used. An advantage of using hardware which is the same as that of the processors 20 and extractors 23 is that the hardware becomes interchangeable in the event of failure, allowing the co-ordinator 12 to instruct a processor 12 to begin operating as a replacement monitor 44, for instance.

The monitor 44 is responsible for monitoring the processors 20 and extractors 23 for failure. This is achieved by reference to the register 38. The monitor 44 continuously scans the register 38, looking for any entries which identify at data fields 40d or 40e that an extraction or processing operation has begun, but has no data at data field 40e or 40h respectively, indicating that the operation has not been completed. In that event, the monitor 44 will refer to data field 40b to determine the operation required. Predetermined data stored within the monitor 44 is then checked to determine whether or not sufficient time has elapsed for the operation to have been completed. In the event that sufficient time has elapsed but the operation has not been completed, the monitor 44 will assume that a failure has occurred within the allocated extractor or processor identified at data field 40c, 40f. The monitor 44 will then over-write the contents of data fields 40c, 40d, 40f and 40g to restore the register entry to its initial condition, i.e. before the request was allocated to an extractor or processor. The monitor 44 can then either actively intervene by identifying an extractor 23 or processor 20 to which the task (now delayed) can be allocated, or leave the register entry in this condition for another extractor 23 or processor 20 to allocate itself to this request, as described above.

Having identified a failed extractor 23 or processor 20 in this way, the monitor 44 then causes that device to be disabled, such as by instructing the co-ordinator 12 to send an appropriate disabling signal to the processor 20 by means of the corresponding connection 36.

In the example described above, extractors 46 are used to create data sub-sets by co-operating with the co-ordinator 12, which contains the register 38, and the server 16 which contains the database contents. The division of tasks between these components can be varied, as will be apparent to the skilled reader, by reference to the nature of the data and the requests, the hardware and software in use, and other factors. However, the coordinator 12, extractors 23 and server 16 will be acting together as a control arrangement responsible for creating the sub-sets.

It can be seen that the operations necessary to satisfy a request are divided into two groups. First, data extraction operations are grouped, resulting in the creation of sub-sets of the database contents by the bank of extractors, stored in data storage areas 28. Secondly, data processing operations are grouped, resulting in data sub-sets being processed by the bank of processors, to create result sets.

The overall efficiency of the apparatus 10 in dealing with requests will be affected by the ratio of the number of extractors 23 and the number of processors 20. For instance, if there are too many extractors 23 in relation to the number of processors 20, data sub-sets will be created at a rate in excess of the rate at which they can be processed, resulting in a backlog of unprocessed data sets in the data storage areas 28. Conversely, if there are too many processors 20 in relation to the number of extractors 23, processors will lie idle, waiting for data sub-sets to be created.

This highlights the significance of implementing the extractors 23 in the same hardware as the processors 20, or in another manner which makes the hardware of the processors 20 and extractors 23 interchangeable. This allows any individual device to act either as a processor or an extractor and thus allows the ratio of processors and extractors to be varied. In particular, it allows this ratio to be varied dynamically, i.e. during operation of the apparatus, in order to seek to maintain the ratio at an appropriate value for conditions then obtaining.

This dynamic reallocation of devices as between processors 20 and extractors 23 is achieved by a further control arrangement 48, here designated a switch, which may itself be a further device identical to the processors 20 and monitor 44, again for reasons of interchangeability. Thus, although a particular device has been labelled as the switch 48 in FIG. 1, any particular device could function as the switch 48 by appropriate software control of its computer 34, as instructed by the co-ordinator 12 over the connection 42.

The switch 48 continuously monitors the apparatus 10 in order to make decisions about the ratio currently required. In particular, the switch 48 monitors the register 38, seeking to identify the number of requests which have been identified but not yet allocated to an extractor, or for which extraction is complete but processing has not been completed. This enables the switch 48 to determine the extraction and processing resources and time required to satisfy any outstanding requests. The switch 48 can then individually instruct devices to act as extractors or processors, using the bus 30, or can instruct the coordinator 12 as to the required ratio, using the bus 36, allowing the co-ordinator 12 to instruct individual devices.

In the event that some result sets are requested on a regular basis (such as monthly, weekly or daily reports), the switch 48 can take into account any requests to be expected in the light of this, within a predetermined future period of time. The switch 48 will also preferably maintain historic data to which reference can be made in order to assess patterns of demand. Thus, demand patterns may be recorded to any degree of sophistication thought appropriate. For instance, comparison of past demand patterns may reveal that large number of requests are received at the beginning of a working day or near the end of a working day, or on particular days of the week or month. Demand patterns are preferably recorded in the co-ordinator 12, to be readily available to the switch 48.

The precise manner in which these or other factors would be used to determine the number of devices to use as processors 20 and as extractors 23 would vary according to the particular application to which the apparatus 10 had been put, but the significance of varying the ratio can be understood more fully by reference to the timing diagram shown in FIG. 4. FIG. 4 is a timing diagram in which time runs horizontally across the page, from left to right. The diagram has five lines, each corresponding to operation of a different hardware components, identified in the left hand column.

Request 1 is received at time T₀. The servers 16a, 16b act with the co-ordinator 12 to identify the operation and data sub-set required to fulfil the request and make an appropriate entry in the register 38, as has been described above. These operations will take until time T₁ to complete. At or shortly after time T₁ an extractor 23 will identify that the creation of a data sub-set is required, and begin the extraction process, completing this at time T₂. At or shortly after time T₂, a processor 20 will identify from the register 38 that a data sub-set has been created and requires processing, and will begin the appropriate processing functions, taking until time T₃, to complete these. At, or shortly after time T₃ the servers 16a, 16b can retrieve the result set from the data area 28 for delivery to the user.

Now consider a second request, received at time T₄, between T₁ and T₂. The server 16b is now free the deal with this request, because the first request is now being advanced by an extractor, and the server 16b is idle. If the duties required by the server 16b are kept as simple as possible, the server 16b is more likely to be available immediately a new request is received.

However, this may result in a second request being dealt with by the server 16b before the first request has been completed by an extractor, at time T₅, i.e. before time T₂. If so, a different extractor will be used to begin the second extraction, while the first extraction is still under way.

Similarly, a second processor will be used for the processing the second request, and can begin at time T₆, before the first processor has finished, at T₃.

It can be seen from this description that receipt of requests and the extraction and processing stages of the request are carried out by a different element of the apparatus 10. After completing one stage of the process, each of those elements is immediately available again for executing the corresponding stage of a different process. Consequently, the processing of several requests can be overlapping in time. If there are sufficient number of devices overall, and the ratio of processors 20 to extractors 23 is appropriate, having regard to the current demands on the apparatus, any delay between each stage of a process and the next can be kept negligibly small, so that each request is processed as quickly as if there was no other request outstanding at that time. Thus, the user is provided with the result set at a speed which suggests that the user is the only current user of the apparatus 10. However, in providing a particular user with that speed of response, the speed of response to other users is not damaged because their corresponding requests are also being processed in the same manner and at the same time with the various stages overlapping with stages of other request processing operations. The result is to improve the efficiency with which the resources of the apparatus 10 are utilised, resulting in better, and more consistent performance as seen by the user.

In particular, as soon as the servers process 15 has noted a request and recorded the details in the register 38, the process 15 is then available to await the next request and respond to it. This contrasts with the position in previously proposed arrangements in which noting, dealing with, and responding to a request was all completed by a single computer system, in effect by the process 15 alone. In that proposal, the computer system would be unable to respond to a further request until an earlier request had been completed, thus resulting in delay, or alternatively, any processing under way would be interrupted by the arrival of another request. By contrast, the arrangements described above allow each stage of a request to be completed by apparatus dedicated to that single operation, without risk of interruption, and therefore able to operate more efficiently.

Technical Requirements

It will be readily apparent to the skilled reader that the principles embodied in the apparatus described above can be implemented in very many different types of hardware and software. In particular, the apparatus could be implemented by installing appropriate computer programmes into otherwise conventional apparatus connected together to create the apparatus described above.

The above description has made reference to the server running a database in SQL (structured query language). Other relational database management systems could be used.

In view of the relative simplicity of the hardware required to implement a device for use as a processor 20, the monitor 44, extractor 23 or switch 48, it will be readily apparent that the overall capacity of the apparatus 10 can be increased readily, by addition of additional devices, thus allowing the workload to increase without adversely affecting performance. It is expected that a significant improvement in the performance of the process 15, as perceived by a user, can be achieved by using only a small number of devices 20, 23, 44, 48, but greater improvement will arise from larger numbers. It is envisaged that as many as 256 devices could readily be incorporated.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Apparatus for operating on the contents of a database to produce a result set relating to those contents, the apparatus comprising:
(a) first data storage means which stores the database contents;
(b) first control means operable to receive requests to produce a result set, and comprising first processor means operable (i) to identify one or more sub-sets of the database contents required to satisfy a request and (ii) to interrogate the first data storage means to extract the or each identified sub-set for further processing;
(c) second data storage means operable to receive and store sub-sets of data extracted by the first processor means in response to corresponding requests; and
(d) at least two second processor means operable simultaneously (i) to act upon respective sub-sets of data stored in the second data storage means to create the corresponding requested result sets and (ii) to provide the result sets for delivery to satisfy the requests.

2. Apparatus according to claim 1, in which the apparatus comprises a plurality of processor means each operable selectably as first processor means and as second processor means, the apparatus further comprising second control means operable to select the manner of operation of each processor means.

3. Apparatus according to claim 2, in which the second control means selects the number of the processor means to be operable as first processor means and as second processor means by reference to at least one of the following factors:
(i) the number of requests which have been received but not satisfied;
(ii) the processing resources and time required to satisfy any outstanding or expected requests;
(iii) the number of requests expected to be received by reference to the current time and to patterns of demand recorded by the second control means, and to any requests stored for execution at a specified future time or times; and
(iv) the number of processor means available for use as first or second processor means.

4. Apparatus according to claim 1, in which the first control means are operable to create a register of requests received.

5. Apparatus according to claim 4, in which the register includes data representing the status of the process required to produce the corresponding result set.

6. Apparatus according to claim 4, in which the register includes data representing the location of the sub-set required for producing the corresponding result set, and the location of the processed data forming the requested result set.

7. Apparatus according to claim 4, in which the register identifies the first processed data forming the requested result set.

8. Apparatus according to claim 4, in which the register identifies the second processor means allocated to create the corresponding result set.

9. Apparatus according to claim 4, in which each first and second processor means will interrogate the register after completing a task, therebeing means operable to identify tasks which have not been allocated, and to allocate an appropriate task to the interrogating processor means.

10. Apparatus according to claim 9, in which the interrogating processor means is operable to update the register when a task has been allocated to it.

11. Apparatus according to claim 4 when dependent on claim 2, in which the second control means are operable to interrogate the register to identify the tasks being undertaken by the processor means, and the identity of the processor means undertaking each of them, and are further operable to determine the time expected for completing each task and to identify any tasks which are overdue for completion.

12. Apparatus according to claim 11, in which the second control means is operable to reallocate an overdue task to a different processing means.

13. Apparatus according to claim 12, in which the second control means is further operable to disable a processor means upon that processor means becoming overdue in completing a task.

14. Apparatus according to claim 1, in which the second processor means are operable to store created result sets in the second data storage means.

15. Apparatus according to claim 1, in which the first control means is operable to retrieve stored created result sets for delivery.

16. Apparatus according to claim 1, in which the apparatus comprises a plurality of first control means as aforesaid, each having associated therewith first processor means as aforesaid, second storage data storage means as aforesaid, and at least two second processor means as aforesaid, the plurality of first control means being cooperable to allocate requests between them for production of a result set as aforesaid.

17. A group of computer programs comprising:
(i) a first computer program for causing a first computer to perform as a first control means of apparatus according to claim 1;
(ii) a second computer program for causing a second computer to perform as a first processor means of apparatus according to claim 1; and
(iii) a third computer program for causing a third computer to perform as a second processor means of apparatus according to claim 1.

18. A method of operating on the contents of a database to produce a result set relating to those contents, in which:
(a) the database contents are stored in first data storage means;
(b) first control means receives requests to produce a result set, and comprises first processor means used (i) to identify the sub-sets of the database contents required to satisfy a request and (ii) to interrogate the first data storage means to extract the identified sub-sets for further processing;
(c) second data storage means are used to receive and store sub-sets of data extracted by the first processor means in response to corresponding requests; and
(d) at least two second processor means are used simultaneously (i) to act upon respective sub-sets of data stored in the second data storage means to create the corresponding requested result sets and (ii) to provide the result sets for delivery to satisfy the requests.

19. A method according to claim 18, in which a plurality of processor means are selectably used either as first processor means or as second processor means.

20. A method according to claim 19, in which the number of the processor means to be used as first processor means and as second processor means are selected by reference to at least one of the following factors:
(i) the number of requests which have been received but not satisfied;
(ii) the processing resources and time required to satisfy any outstanding or expected requests;
(iii) the number of requests expected to be received by reference to the current time and two patterns of demand recorded by the second control means, and to any requests stored for execution at a specified future time or times; and
(iv) the number of processor means available for use as first or second processor means.

21. A method according to claim 19, in which a register of requests received is created.

22. A method according to claim 21, in which the register includes data representing the stage reached in the process required to produce the corresponding report.

23. A method according to claim 21, in which the register includes data representing the location of the sub-set required for producing the corresponding result set, and the location of the processed data forming the requested result set.

24. A method according to claim 21, in which the register identifies the first processor means allocated to each request.

25. A method according to claim 21, in which the register identifies the second processor means allocated to create the corresponding result set.

26. A method according to claim 21, in which each first and second processor means will interrogate the register after completing a task, there being means operable to identify tasks which are not being processed, and to allocate an appropriate task to the interrogating processor means.

27. A method according to claim 26, in which the interrogating processor means is used to update the register when a task has been allocated to it.

28. A method according to claim 26, in which the register is interrogated to identify the tasks being undertaken by the processor means, and the identity of the processor means undertaking each of them, and the time expected for completing each task is determined to identify any tasks which are overdue for completion.

29. A method according to claim 28, in which an overdue task is reallocated to a different processing means.

30. A method according to claim 29, in which a processor means is disabled upon that processor means becoming overdue in completing a processing task.

31. A method according to claim 18, in which created result sets are stored in the second data storage means for retrieval and delivery.

32. Apparatus for creating a result set from a database having data stored therein, the apparatus comprising:
(a) first data storage means for storing the contents of said database;
(b) first control means for receiving requests to produce a result set, said first control means comprising first processor means for (i) identifying at least one sub-set of said database contents required to satisfy said request and (ii) interrogating said first data storage means for extracting each identified subset for further processing;
(c) second data storage means for receiving and storing sub-sets of data extracted by said first processor means in response to corresponding requests; and
(d) at least two second processor means for simultaneously (i) acting upon respective sub-sets of data stored in said second data storage means for creating result sets in fulfilment of corresponding requests and (ii) for providing said result sets for delivery to satisfy said requests.

33. A method of operating on database contents to produce a result set relating to those contents, comprising the steps of:
(a) storing said database contents in a first data storage means;
(b) receiving a request to produce a result set;
(c) identifying sub-sets of said database contents required to satisfy a request;
(d) interrogating said first data storage means to extract said identified sub-sets for further processing;
(e) receiving and storing in second data storage means sub-sets of data extracted by said first processor means in response to corresponding requests; and
(f) simultaneously using at least two second processor means (i) to act upon respective sub-sets of data stored in said second data storage means to create result sets in fulfilment of corresponding requests and (ii) delivering said result sets to satisfy said requests.
